(19) United States
(12) Patent Application Publication
(10) Pub. No.: US 2018/0160693 A1
(43) Pub. Date: Jun. 14, 2018

(54) SMOKING SLICES

(71) Applicant: Frank Anthony Skero, Sr., Spring, TX (US)

(72) Inventor: Frank Anthony Skero, Sr., Spring, TX (US)

(21) Appl. No.: 15/842,600

(22) Filed: Dec. 14, 2017

Related U.S. Application Data
(60) Provisional application No. 62/434,253, filed on Dec. 14, 2016.

(51) Int. Cl. A23B 4/052; A23L 5/10

(52) U.S. Cl. CPC A23B 4/052; A23V 2002/00; A23L 5/10

(57) ABSTRACT

A device includes a body and a plurality of holes located on the body, and each of the plurality of holes defining a cavity therein. The device may be a wood block made from a wood material. Further, the device is useful for providing an improved means for efficiently and quickly smoking food-items.

### CROSS REFERENCE TO RELATED APPLICATION

The present application is related to and claims priority to U.S. Provisional Patent Application No. 62/434,253 filed Dec. 14, 2016, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. FIELD OF THE INVENTION

The present invention relates generally to the field of food smoking and more specifically relates to a wood block for smoking food items over a flame.

### 2. DESCRIPTION OF RELATED ART

There is a recognized need to provide means for flavoring food by smoking. Certain woods—for example, hickory—impart a particularly delicious flavor to foods cooked in their smoke. However, infusing food with smoked flavor can be difficult and time-consuming. Wood dries out quickly and must be soaked in water before cooking. Even while meticulously performing each step, smoky flavor may not be efficiently infused into food while grilling. Thus, a suitable solution is desired.

U.S. Pat. No. 4,941,889 to Emerson B. Holmes relates to barbecue flavoring blocks. The described barbecue flavoring blocks includes barbecue flavoring blocks and a process for making barbecue flavoring block made from pieces of wood suitable to flavor food bound together with gelatin, preferably containing a flavoring ingredient. The flavoring blocks are pasturized.

### BRIEF SUMMARY OF THE INVENTION

In view of the foregoing disadvantages inherent in the known food smoking art, the present disclosure provides a novel food smoking device and method. The general purpose of the present disclosure, which will be described subsequently in greater detail, is to provide an improved means for efficiently and quickly smoking food-items.

A device is disclosed herein. The device includes a body which may include a thickness defined by a top-surface and a bottom-surface opposite the top-surface. The body may be made from a wood-material configured to produce a smoke when in contact with the flame. Further, the top-surface may be configured to receive the at least one food-item. In addition to this, a plurality of holes may be located on the body. Each of the plurality of holes may define a cavity through the thickness from the top-surface to the bottom-surface of the body. In addition, the plurality of holes may be configured to enable the flame to heat the at least one food-item.

A method of using device is also disclosed herein. The method of using device may comprise the steps of: a providing the device as above; placing the bottom-surface of the body on the flame to produce the smoke; placing the at least one food-item on the top-surface of the body to infuse the at least one food-item with the smoke, and to heat the at least one food-item; and removing the at least one food-item from the top-surface of the body.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a food smoking device and method, constructed and operative according to the teachings of the present disclosure.

FIG. 1 is a top perspective view of the device during an ‘in-use’ condition, according to an embodiment of the disclosure.

FIG. 2 is a front-top perspective view of the device of FIG. 1, according to an embodiment of the present disclosure.

FIG. 3 is a top perspective view of the device of FIG. 1, according to an embodiment of the present disclosure.

FIG. 4 is a front perspective view of the device of FIG. 1, according to an embodiment of the present disclosure.

FIG. 5 is a flow diagram illustrating a method of use for the present device, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to food smoking means and more particularly to a food smoking device and method as used to improve the wood blocks for smoking food items over a flame.

Generally, disclosed is a smoking tool used in conjunction with a grill. The tool may feature slices of natural wood, arranged in a circular, rectangle, or square shape, in order to act as a way to infuse food with smoky flavor. This may cook food quickly in order to create a locked-in flavor effect for meats, vegetables, and other types of food cooked on the grill. Further, the tool may eliminate the need to soak wood chips and perform other time-consuming processes in order to create smoked flavor in foods. Thus, the tool may save extensive time and effort while grilling and smoking food.

The tool may be a wooden cooking tool for grilling. The tool may enable users to easily infuse meats, vegetables, and other foods with smoked flavors. Holes may be drilled into the tool to enable food to cook quickly and infuse the food with more flavor than traditional smoking methods. In use, the tool may be set on the grill and may begin smoking from the flame of the fire, creating a locked-in flavor effect. In addition, the tool may be constructed using wood and other suitable materials. The tool may measure approximately 18″ in circumference and 1-2″ in thickness; however, various sizes may be available in order to accommodate all user needs and preferences. Exact size, measurement, construction, and design specifications may vary upon manufacturing.

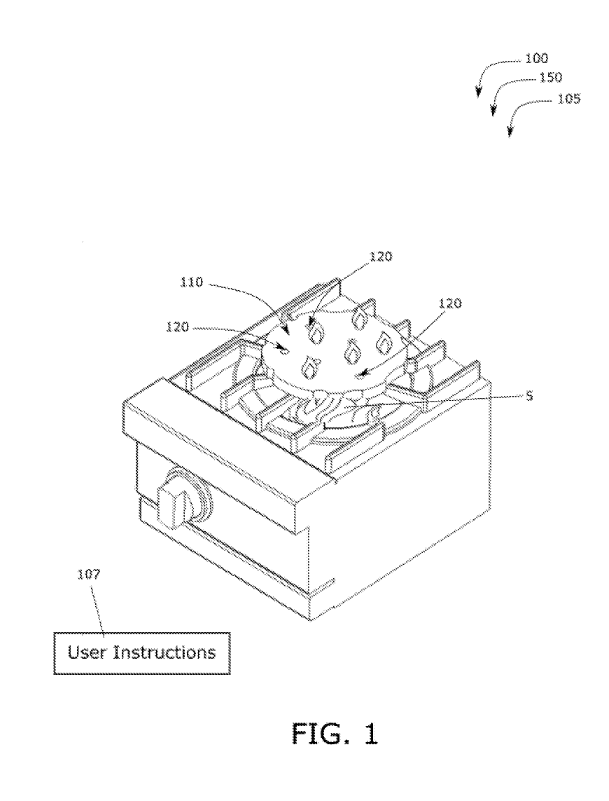

Referring now more specifically to the drawings by numerals of reference, there is shown in FIGS. 1-5, various views of a device 100.

FIG. 1 shows the device 100 during an ‘in-use’ condition 150, according to an embodiment of the present disclosure. As Illustrated, the device 100 may include a body 110 and a plurality of holes 120. The device 100 may be used for smoking at least one food-item 10 over a flame 5.

According to one embodiment, the device 100 may be arranged as a kit 105. The kit 105 may include set of instructions 107. The instructions 107 may detail functional relationships in relation to the structure of the device 100 (such that the device 100 can be used, maintained, or the like, in a preferred manner).

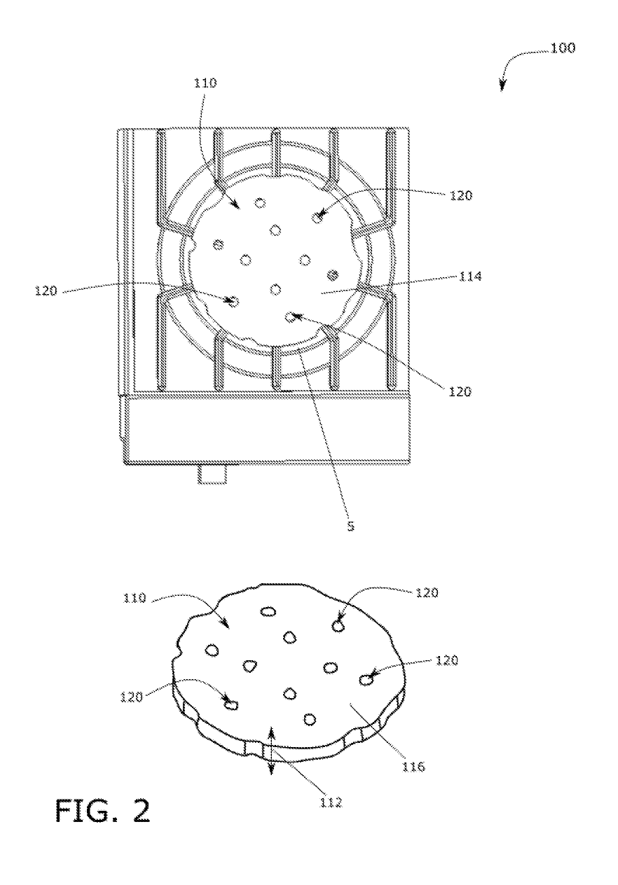

Referring now to FIG. 2 showing a front perspective view of the device 100 of FIG. 1, according to an embodiment of the present disclosure. The body 110 may include a thickness 112 defined by a top-surface 114 and a bottom-surface 116 opposite the top-surface 114, and as illustrated, the top-surface 114 may be configured to receive the at least one food-item 10. The body 110 may be made from a wood-material configured to produce a smoke when in contact with the flame 5. The wood-material may be a variety of different types of wood. For example, the wood-material may be chosen from hickory, mesquite, oak, pecan, cedar, black walnut or the like. The type of wood may be chosen by the user with regard to what flavor smoke they wish to infuse into the at least one food-item 10. The choice may also depend on the food-item 10, whether it be beef, chicken, fish, etc. It is also contemplated that the at least one food-item 10 may be a liquid-item, such as a beverage. Other wood and flavoring means may be used.

As shown, in a preferred embodiment, the flame 5 may be a grill, and the bottom-surface 116 may be rested on the grill during the smoking of the at least one food-item 10. Other examples of the flame 5 may be a Bunsen burner, a barbecue, or the like. In all embodiments, the top-surface 114 is not to be taken for use exclusively as the ‘top’ of the body 110, and the bottom-surface 116 is not to be taken for use exclusively as the ‘bottom’ of the body 110; the top-surface 114 and the bottom-surface 116 are relative to the flame 5, such that the user may use either surface for resting on the grill or for placing the food-item 10 thereon.

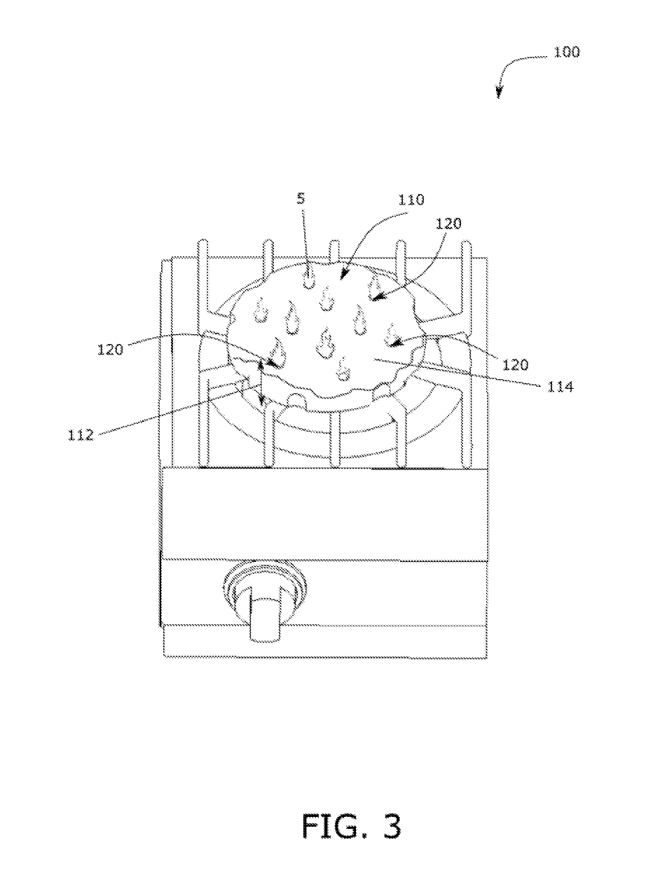

FIG. 3 shows a front perspective view of the device 100 of FIG. 1, according to an embodiment of the present disclosure. The plurality of holes 120 may be located on the body 110, and each of the plurality of holes 120 may define a cavity through the thickness 112 from the top-surface 114 to the bottom-surface 116 of the body 110. The plurality of holes 120 may be configured to enable the flame 5 to heat the at least one food-item 10, thus enabling the flame 5 to cook the at least one food-item 10 faster. Further, the plurality of holes 120 may be configured to enable the smoke being generated inside each of the plurality of holes 120 to permeate the a least one food-item 10.

The thickness 112 of the body 110 may be equivalent to the length of each of the plurality of holes 120, the length may be measured from top-surface 114 to the bottom-surface 116 of the body 110. In the preferred embodiment, each of the plurality of holes 120 may be circular in shape and include a circumference of at least 2 inches. However, it should be appreciated that each of the plurality of holes 120 may include a variety of different shapes. For example, each of the plurality of holes 120 may be square in shape or rectangular in shape. Further, the body 110 may include a plurality of slits defining an elongated cavity through the thickness 112 from the top-surface 114 to the bottom-surface 116 of the body 110, and configured to provide the same functionality as the plurality of holes 120.

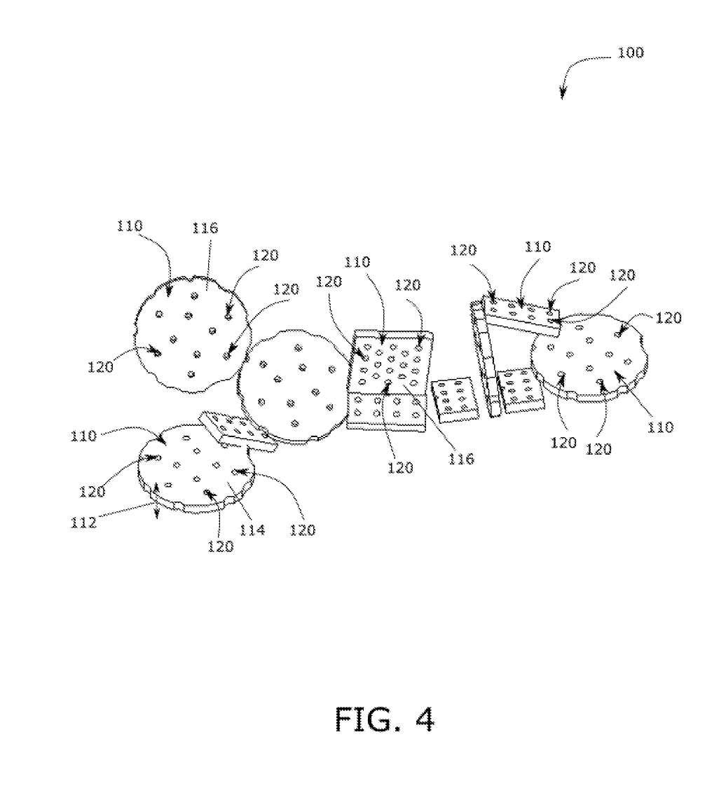

Referring now to FIG. 4 showing a front perspective view of the device 100 of FIG. 1, according to an embodiment of the present disclosure. In the preferred embodiment, the body 110 may include a circular-shape. In this embodiment, a circumference of the body 110 may be at least 18 inches. Further, the thickness 112 of the body 110 may be at least 2 inches. However, it should be appreciated that the body 110 may be a variety of different sizes. As above, the thickness 112 of the body 110 may be equivalent to the length of each of the plurality of holes 120; the length may be measured from top-surface 114 to the bottom-surface 116 of the body 110. In one embodiment, each of the plurality of holes 120 may include a circumference of at least 2 inches. However, as above, it should be appreciated that the holes may be a variety of different sizes.

In other embodiments, the body 110 may include different shapes. For example, the body 110 may be a square-shape, a rectangular-shape, or a triangular-shape. Further to this, it is contemplated that a handle may be included on the body 110 (not shown in the figures), and configured to provide a means for safely placing the device 100 onto the flame 5.

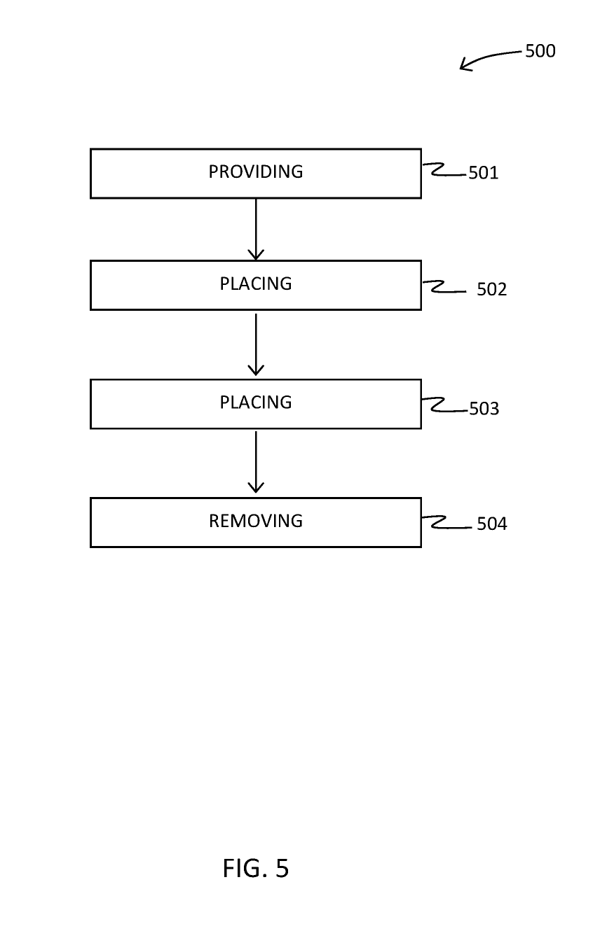

FIG. 5 is a flow diagram 550 illustrating a method for smoking at least one food-item over a flame 500, according to an embodiment of the present disclosure. As illustrated, the method for smoking at least one food-item over a flame 500 may include the steps of: step one 501, providing the device 100 as above; step two 502, placing the bottom-surface 116 of the body 110 on the flame 5 to produce the smoke; step three 503, placing the at least one food-item 10 on the top-surface 114 of the body 110 to infuse the at least one food-item 10 with the smoke, and to heat the at least one food-item 10; and step four 504, removing the at least one food-item 10 from the top-surface 114 of the body 110.

It should be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for device 100 (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A device for smoking at least one food-item over a flame, the device comprising:
a body, the body including a thickness defined by a top-surface and a bottom-surface opposite the top-surface, the body being made from a wood-material configured to produce a smoke when in contact with the flame, and wherein the top-surface is configured to receive the at least one food-item; and
a plurality of holes located on the body, each of the plurality of holes defining a cavity through the thickness from the top-surface to the bottom-surface of the body, and wherein the plurality of holes are configured to enable the flame to heat the at least one food-item.

2. The device of claim 1, wherein the wood-material is hickory.

3. The device of claim 1, wherein the wood-material is mesquite.

4. The device of claim 1, wherein the wood-material is oak.

5. The device of claim 1, wherein the wood-material is alder.

6. The device of claim 1, wherein the wood material is maple.

7. The device of claim 1, wherein the wood-material is apple-wood.

8. The device of claim 1, wherein the wood-material is cherry-wood.

9. The device of claim 1, wherein the body includes a circular-shape.

10. The device of claim 9, wherein the body includes a circumference of at least 18 inches.

11. The device of claim 10, wherein the thickness of the body is at least 2 inches.

12. The device of claim 11, wherein the thickness of the body is equivalent to a length of each of the plurality of holes.

13. The device of claim 12, wherein each of the plurality of holes include a circumference of at least 2 inches.

14. The device of claim 1, wherein the body includes a square-shape.

15. The device of claim 1, wherein the body includes a rectangular-shape.

16. The device of claim 1, wherein the flame is a grill, and the bottom-surface is rested on the grill during the smoking of the at least one food-item.

17. The device of claim 1, further comprising a handle configured to provide a means for safely placing the device onto the flame.

18. A device for smoking at least one food-item over a flame, the device comprising:
a body, the body including a thickness defined by a top-surface and a bottom-surface opposite the top-surface, the body being made from a wood-material configured to produce a smoke when in contact with the flame, and wherein the top-surface is configured to receive the at least one food-item; and
a plurality of holes located on the body, each of the plurality of holes defining a cavity through the thickness from the top-surface to the bottom-surface of the body, and wherein the plurality of holes are configured to enable the flame to heat the at least one food-item; and
wherein the body includes a circumference of at least 18 inches;
wherein the thickness of the body is at least 2 inches;
wherein the thickness of the body is equivalent to a length of each of the plurality of holes;
wherein each of the plurality of holes include a circumference of at least 2 inches;
wherein the flame is a grill, and the bottom-surface is rested on the grill during the smoking of the at least one food-item; and
wherein the device further includes a handle configured to provide a means for safely placing the device onto the flame.

19. The device of claim 17, further comprising set of instructions; and
wherein the device is arranged as a kit.

20. A method for smoking at least one food-item over a flame, the method comprising the steps of:
providing a device for smoking the at least one food-item over the flame, the device including:
a body, the body including a thickness defined by a top-surface and a bottom-surface opposite the top-surface, the body being made from a wood-material configured to produce a smoke when in contact with the flame, and wherein the top-surface is configured to receive the at least one food-item; and
a plurality of holes located on the body, each of the plurality of holes defining a cavity through the thickness from the top-surface to the bottom-surface of the body, and wherein the plurality of holes are configured to enable the flame to heat the at least one food-item;
placing the bottom-surface of the body on the flame to produce the smoke;
placing the at least one food-item on the top-surface of the body to infuse the at least one food-item with the smoke, and to heat the at least one food-item; and
removing the at least one food-item from the top-surface of the body.
